(19) United States
(12) Patent Application Publication
(10) Pub. No.: US 2011/0198903 A1
(43) Pub. Date: Aug. 18, 2011

(54) Elastomeric bicycle saddle cover

(76) Inventor: Ivan Sebastian, Toronto (CA)

(21) Appl. No.: 12/656,656

(22) Filed: Feb. 12, 2010

(51) Int. Cl. B62J 1/20; G09F 21/04

(52) U.S. Cl. 297/219.11

(57) ABSTRACT

A removable bicycle saddle cover designed to keep the bicycle saddle dry from the elements and constructed entirely of an elastomeric material such as rubber latex. The cover is molded in the shape of a bicycle saddle, with the ability to stretch over and under the saddle and to fit virtually any bicycle saddle shape and size.

### BACKGROUND OF INVENTION

1. Field of Invention

The present invention relates to removable bicycle saddle covers.

2. Description of Prior Art

There are many instances where it is desirable to keep the bicycle saddle dry from the elements, especially when the bicycle is used for commuter purposes and is frequently left outdoors for extended periods of time. In these instances, the need to keep the seat dry and moisture free is important, as it comes to contact with the bicycle rider's clothing and thus would interfere with a comfortable ride.

There have been a number of types of bicycle saddle covers proposed in the prior art, however, they all have been subject to competing trade-offs between effectiveness, simplicity of use, ease of storage and manufacturing costs. Tarpaulin-like covers made of polyester or other rigid waterproof materials are relatively expensive to manufacture and cannot snugly fit the multitudes of bicycle saddle shapes and sizes currently in use. Also, bicycle saddle covers made of rigid materials are bulky, aesthetically not pleasing and difficult to store. In addition, the above mentioned bicycle saddle covers require straps and/or other devices to keep them attached to the bicycle saddle, making them impractical and difficult to use.

### SUMMARY OF THE INVENTION

The object of the present invention is to provide a removable bicycle saddle cover that keeps the seat dry from the elements, is small enough to be stored under the seat, is inexpensive to manufacture, fits snugly over different saddle shapes and sizes and is aesthetically pleasing.

According to the invention, the entire seat cover assembly (one hundred percent) consists of a thin flexible elastomeric material, such as rubber latex, molded in the shape of a bicycle saddle. Due to the elastic properties of the elastomeric material, the cover can be much smaller than a typical bicycle saddle, but when stretched, it will extend over bicycle saddles of different shapes and sizes, ensuring a snug fit and requiring no additional attachment devices. The manufacturing cost of the saddle cover is very low as it uses the same manufacturing process used in the manufacturing of disposable latex gloves.

In another embodiment of the invention, the bicycle saddle cover may serve as an advertising billboard. As commuter bicycles are parked in urban locations with high pedestrian traffic, the elastic seat cover serves as an advertising platform. In this embodiment of the invention, the seat cover is manufactured in different colors with printed logos and messages, using standard silk screen printing techniques. Due to its low manufacturing cost, it serves as a promotional item and is given away for free.

### BRIEF DESCRIPTION OF THE DRAWINGS

FIG. 1 is a bottom view of a bicycle saddle with an elastomeric cover attached over the saddle.

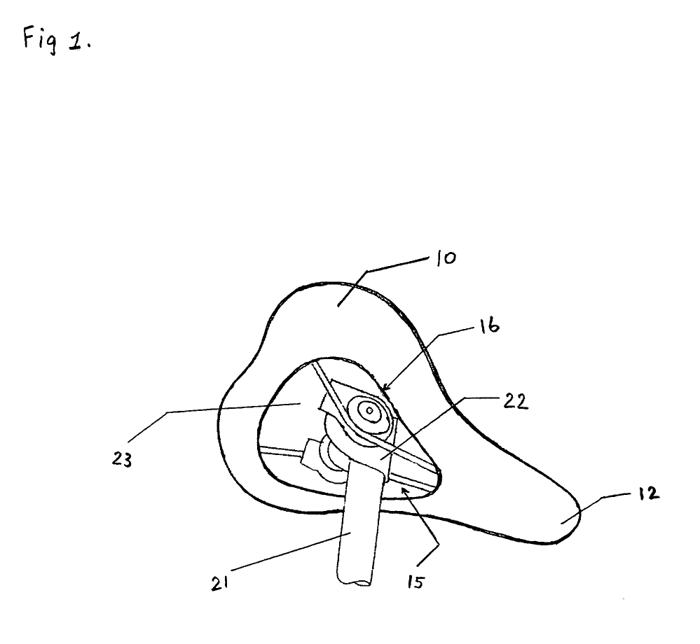

FIG. 2 is a top view of the elastomeric cover not attached to a saddle.

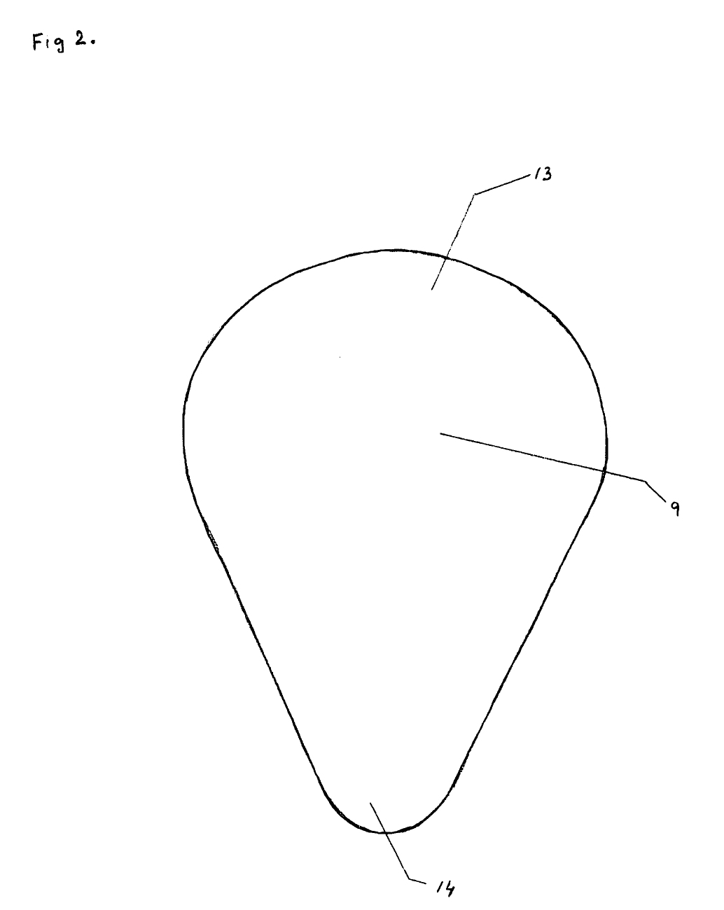

FIG. 3 is a bottom view of the elastomeric cover not attached to a saddle.

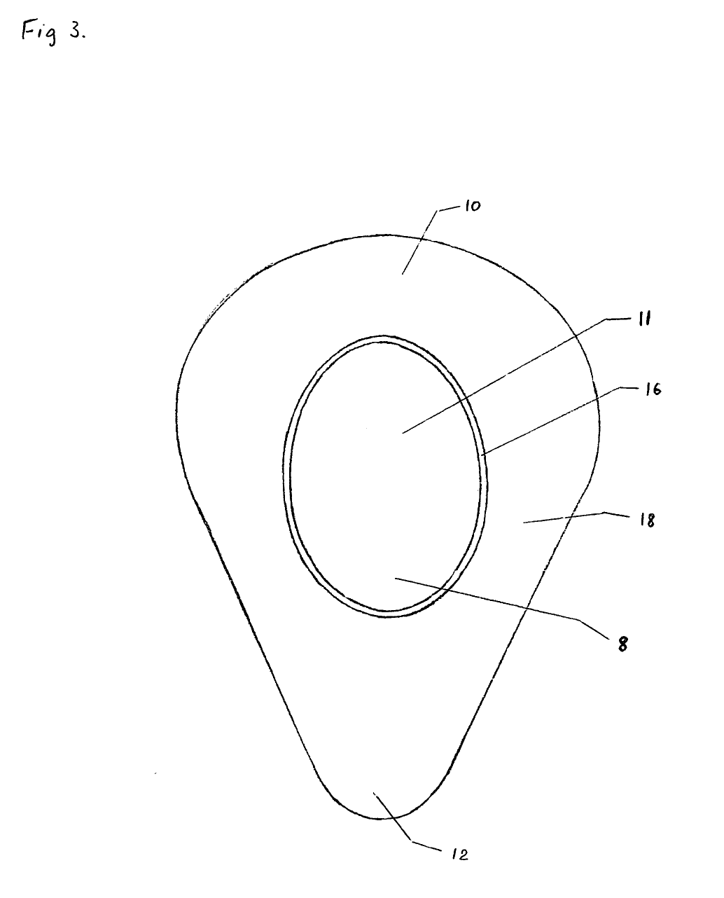

FIG. 4. is a 3 dimensional bottom view drawing of the elastomeric cover not attached to a saddle.

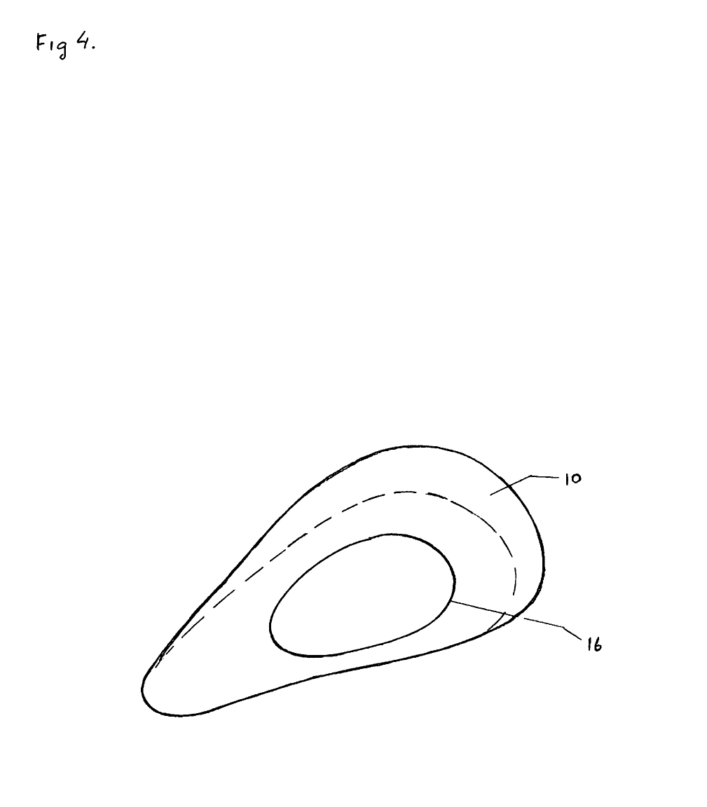

FIG. 5. is a cross section lengthwise showing the opening and the rolled bead reinforcement.

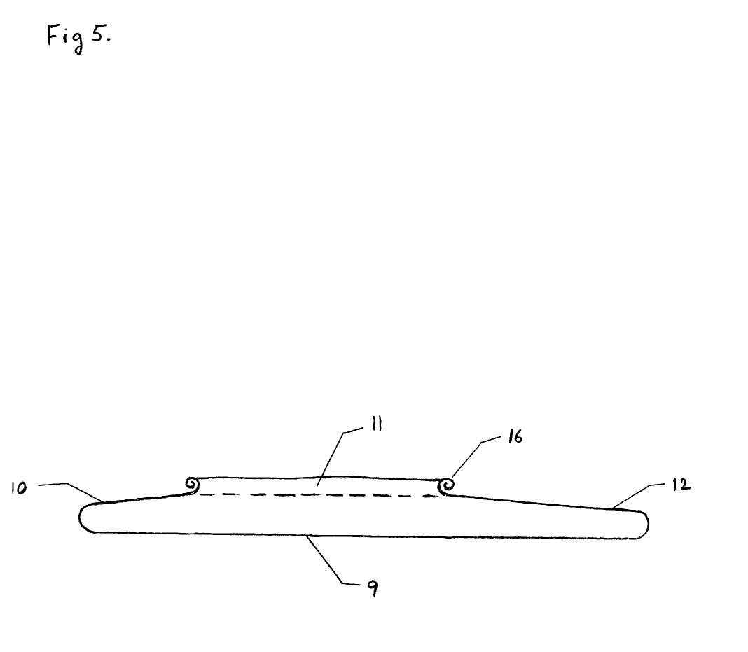

### DETAIL DESCRIPTION

The seat cover is pear shaped, with a curved edge extending around the periphery, varying from approximately one to three inches. The base of the seat cover (10) and (13) is wider and the curved edge is shaped to fit the rearward portion of the bicycle saddle.

The cover gets progressively narrower towards the tip of the seat cover (12) and (14), which is shaped to fit the forward portion of the bicycle saddle. The edges on the periphery of the seat cover are curved inwards extending beneath the bicycle saddle (15) in a way that does not interfere with the saddle assembly (22) or the saddle post (21). The curved edges (18) surround a circular or oval opening (11) which is reinforced by a rolled bead (16).

The saddle cover is completely enclosed except for the opening (11) and forms an outer surface (9), (10), (12), (13), (14), (18) and an inner surface (8). The outer surface of the cover is exposed to the elements but the inner surface (8), which comes in contact with the saddle, stays dry. To place the saddle cover over a bicycle saddle, the tip of the saddle must slip through the opening (11) and the rolled bead (16), at the edge of the opening, must be stretched with both hands over the sides and rear part of the saddle.

While riding, the saddle cover may be rolled up and stored under the saddle above the saddle assembly (23). The natural elasticity of the material keeps the cover in place as it is squeezed into a small space above the saddle post (21), preventing it from falling out.

I claim:

1. A bicycle saddle cover constructed entirely of a thin waterproof elastomeric material between 1 and 30 mils (thousands of an inch) in thickness. The saddle cover is fully enclosed and has an inner and outer surface. The two surfaces meet at a round or oval opening at the bottom of the saddle cover, sufficient in size to stretch over the bicycle saddle. The opening is reinforced with the elastomeric material being rolled onto itself in a so called “rolled bead”, thus increasing the thickness of the cover at the edges of the opening, preventing them from tearing. When placed over a bicycle saddle the cover completely encloses the saddle in a tight fit, including the top of the saddle, the front of the saddle, the sides of the saddle, the rear of the saddle and extending from all sides to the bottom of the bicycle saddle up to the round or oval reinforced opening. The cover's outer surface is exposed to the elements such as rain while the inner surface stays dry, thus protecting the bicycle saddle and keeping it dry.

2. In another embodiment of the invention, the elastomeric bicycle saddle cover is used as a medium for advertising. The saddle cover is manufactured in different base colors and contains printed logos and messages in one or more colors. Due to the tight fit of the elastomeric cover, the message appears to be printed directly on the saddle in a natural and aesthetically pleasing way as part of the bicycle as a whole. In this embodiment, due to its low manufacturing cost, the saddle cover is given away free as a promotional item to bicycle riders who will use it to protect their saddles from the elements and at the same time expose the advertising message to pedestrian traffic, while their bicycle is parked.
